(19) United States
(12) Patent Application Publication
(10) Pub. No.: US 2008/0278613 A1
(43) Pub. Date: Nov. 13, 2008

(54) Methods, apparatuses and systems providing pixel value adjustment for images produced with varying focal length lenses

(75) Inventors: Gregory Michael Hunter, San Jose, CA (US); Ji Soo Lee, Santa Clara, CA (US)

Correspondence Address: DICKSTEIN SHAPIRO LLP, 1825 EYE STREET NW, Washington, DC, 20006-5403, US

(73) Assignee: MICRON TECHNOLOGY, INC.

(21) Appl. No.: 11/798,281

(22) Filed: May 11, 2007

(51) Int. Cl. H04N 5/335

(52) U.S. Cl. 348/308; 348/E05.091

(57) ABSTRACT

Methods, apparatuses and systems are disclosed for providing pixel value corrections in accordance with the focal length of a variable focal length lens used to capture an image. Two or more adjustment surfaces, each corresponding to a focal length of said lens, are stored. If an image is captured using a focal length of the lens which does not correspond to a stored adjustment surface, an interpolated or extrapolated adjustment surface is determined and applied to a captured image.

### FIELD OF THE INVENTION

Embodiments relate generally to pixel value adjustments for captured images to account for pixel value variations caused by varying focal length lenses.

### BRIEF DESCRIPTION OF THE INVENTION

Imagers, for example CCD, CMOS and others, are widely used in imaging applications, for example, in digital still and video cameras.

It is well known that for a given optical lens used with a digital still or video camera, the pixels of the pixel array will generally have varying signal values even if the imaged scene is of uniform irradiance. The varying responsiveness depends on a pixel's spatial location within the pixel array. One source of such variations is lens shading. Lens shading can cause pixels in a pixel array located farther away from the center of the pixel array to have a lower value when compared to pixels located closer to the center of the pixel array, when the camera is exposed to a scene of uniform irradiance that is uniformly illuminated. Other sources may also contribute to variations in a pixel value with spatial location, and more complex patterns of spatial variation may also occur. Such variations in a pixel value can be compensated for by adjusting, for example, the gain applied to the pixel values based on spatial location in a pixel array. For lens shading adjustment, for example, it may happen that the further away a pixel is from the center of the pixel array, the more gain is needed to be applied to the pixel value. Different color channels may exhibit different spatial patterns of lens shading; for example, the “center” of the shading pattern may differ per color channel.

In addition, sometimes an optical lens is not centered with respect to the optical center of the imager; the effect is that lens shading may not be centered at the center of the imager pixel array. Other types of changes in optical state and variations in lens optics may further contribute to a non-uniform pixel response across the pixel array. For example, variations in iris opening or focus position may affect a pixel value depending on spatial location.

Variations in the shape and orientation of photosensors and other elements used in the pixels may also contribute to a non-uniform spatial response across the pixel array. Further, spatial non-uniformity may be caused by optical crosstalk or other interactions among the pixels in a pixel array.

Variations in a pixel value caused by the spatial position of a pixel in a pixel array can be measured and the pixel response value can be adjusted with a pixel value gain adjustment. Lens shading, for example, can be adjusted using a set of positional gain adjustment values, which adjust pixel values in post-image capture processing. With reference to positional gain adjustment to compensate for shading variations with a fixed optical state/configuration, gain adjustments across the pixel array can typically be provided as pixel signal correction values, one corresponding to each of the pixels. The set of pixel signal correction values for the entire pixel array forms a gain adjustment surface for each of a plurality of color channels. The gain adjustment surface is applied to pixels of the corresponding color channel during post-image capture processing to correct for variations in pixel values due to the spatial location of the pixels in the pixel array.

When a gain adjustment surface is determined for a specific color channel/camera/lens/IR-cut filter, illuminant/scene, etc. combination, it is generally applied to all captured images from an imager of the same design. This does not present a particular problem when a camera lens has a fixed focal length. Lenses having variable focal lengths, such as zoom lenses, however, will generally need different pixel adjustment/“correction” values for each color channel at each different focal length. These varying “corrections” cannot be accurately implemented using a single gain adjustment surface per color channel. Accordingly, it would be beneficial to have a variety of gain adjustment surfaces available for each color channel for different focal lengths to correct for the different patterns of pixel value spatial variations at the different focal lengths. It would also be beneficial to correct variations in the required adjustment caused e.g., by changes in iris opening and differing focus position.

It may be possible to address the problem of different focal lengths of a lens by storing a relatively large number of sets of gain adjustment surfaces, each set containing a correction surface for each color channel and corresponding to one of the many possible focal lengths of a given lens. The storage overhead, however, would be large and a large amount of retrieval time, energy and power would be consumed when zooming and/or changing other optical state, for example, during video image capture as an appropriate gain adjustment surface is retrieved for a given focal length before being applied to the captured image.

Accordingly, improved methods, apparatuses and systems providing spatial pixel signal gain adjustments for use with pixel values of images captured using a variable focal length lens and/or other changing optical states are desirable.

### BRIEF DESCRIPTION OF THE DRAWINGS

FIG. 1 illustrates a block diagram of a system-on-a-chip imager implementing a disclosed embodiment.

FIG. 2 illustrates an example of a sensor core used in the FIG. 1 imager.

FIG. 3 illustrates a process for creating positional gain adjustment surfaces in accordance with disclosed embodiments.

FIG. 4 illustrates examples of positional gain adjustment surfaces for certain focal lengths of an example variable focal length lens in accordance with disclosed embodiments.

FIG. 5 illustrates a process for correcting the pixel values for a captured image in accordance with disclosed embodiments.

FIG. 6 illustrates a process for performing the pixel value adjustment of step 506 of FIG. 5 in accordance with disclosed embodiments.

FIG. 7 illustrates a process for performing the pixel value adjustment of step 506 of FIG. 5 in accordance with disclosed embodiments.

FIG. 8 illustrates a processing system, for example, a digital still or video camera processing system constructed in accordance with disclosed embodiments.

### DETAILED DESCRIPTION OF THE INVENTION

In the following detailed description, reference is made to the accompanying drawings which form a part hereof, and in which is shown by way of illustration specific disclosed embodiments. These disclosed embodiments are described in sufficient detail to enable those skilled in the art to make and use them, and it is to be understood that structural, logical or procedural changes may be made.

In the description below, processes for processing pixel values are described by way of flowchart. In some instances, steps which follow other steps may be in reverse or in a different sequence except where a following procedural step requires the presence of a prior procedural step. Disclosed embodiments may be implemented in an image processor circuit which provides an image processing pipeline for processing a pixel array of pixel values. This circuit can be formed of discrete logic circuits, an ASIC, programmed processor or any combination of hardware or software programmable devices.

For purposes of simplifying description, the disclosed embodiments are described in connection with performing positional gain adjustment of the pixel values of a captured image for shading variations. For the same purpose, the disclosed embodiments are described in connection with changing focal lengths. However, the disclosed embodiments may also be used for any pixel value corrections determined by spatially varying patterns of correction parameters to correct for, for example, zoom lens position variations, iris opening variations, focus position variations, and for different light source color temperatures, etc. either separately or in combination. Such embodiments may employ more than one correction parameter per pixel, per channel; thus multiple surfaces, each representing one parameter, may be required per pixel, per channel, per focal length, per iris opening, etc.

Disclosed embodiments may store each of a plurality of positional gain adjustment surfaces as either a plurality of positional gain adjustment values themselves or as a set of parameters representing the positional gain adjustment surface which can be used to generate the surface. For example, a positional gain adjustment surface may be represented by sets of piecewise-quadratic, piecewise-linear, linear, polynomial, or other functions, and sets of parameters for generating these functions may be stored. For ease of discussion and for simplifying description, a positional gain adjustment surface stored in either manner will be referred to throughout as a “stored positional gain adjustment surface.” Each stored positional gain adjustment surface corresponds to a respective focal length of a lens. For stored positional gain adjustment surfaces which are stored as sets of parameters, the sets of parameters are used to generate the values of the positional gain adjustment surfaces, as described in more detail below. Briefly described, generation of the positional gain adjustment surface comprises a calculation of the positional gain adjustment correction value for each pixel from a function described by the stored parameters. The positional gain adjustment correction value for each pixel may then be used during positional gain adjustment of that pixel's value.

Disclosed embodiments implement positional gain adjustment of pixel values using stored positional gain adjustment surfaces. Further, a different positional gain adjustment surface may be provided for each of a plurality of color channels of a pixel array. For example, in a Bayer pattern R, G, B array, three color channels are present, in which case three color channels and associated positional gain adjustment surfaces are employed. In addition, the green color channel can be further separated into a green1 and a green2 color channel, in which case four color channels and associated positional gain adjustment surfaces are employed.

A corrected pixel value P(x, y), where (x, y) represents pixel location in a pixel array relative to a pixel (0, 0), is the captured image pixel value P_{IN}(x, y) multiplied by a positional gain adjustment surface correction value, which surface can be represented as a correction function, F(x, y) to produce a pixel value, as shown in Equation (1):

P(x, y)=P_{IN}(x, y)*F(x, y) (1)

The correction function, F(x, y), represents a positional gain adjustment surface for a given color channel. One non-limiting example of a correction function F(x, y) which may be used is described in copending application Ser. No. 10/915,454, entitled CORRECTION OF NON-UNIFORM SENSITIVITY IN AN IMAGE ARRAY, filed Aug. II, 2004 (“the '454 application”) the disclosure of which is incorporated herein by reference in its entirety. The correction function described in the '454 application may be represented by Equation (2):

F(x,y)=θ(x,x²)+φ(y,y²)+kp*θ(x,x²)*φ(y,y²)−G (2)

where θ(x, x²) represents a piecewise-quadratic correction function in the x direction of a pixel array, φ(y, y²) represents a piecewise-quadratic correction function in the y-direction, kp*θ(x, x²)*φ(y, y²) is used to increase off-axis correction values e.g., in the pixel array corners and a constant G represents a “global” adjustment. The value of F(x, y) for a given pixel (x, y) is the pixel correction value of the positional gain adjustment surface for that pixel (x, y) location for the given color channel. A more complete explanation of the use of F(x, y) in Equation (2) may be found in the '454 application.

It should be noted that F(x, y) described by Equation (2) is only one example of a function which represents a stored positional gain adjustment surface and that other functions may alternatively be used. Additional examples of correction functions are described in copending application Ser. Nos. 11/512,303, entitled METHOD, APPARATUS, AND SYSTEM PROVIDING POLYNOMIAL BASED CORRECTION OF PIXEL ARRAY OUTPUT, filed Aug. 30, 2006 (“the '303 application”) and Ser. No. 11/514,307, entitled POSITIONAL GAIN ADJUSTMENT AND SURFACE GENERATION FOR IMAGE PROCESSING, filed Sep. 1, 2006 (“the '307 application), the disclosures of which are incorporated herein by reference in their entirety. The correction function F(x, y) in the '303 application is represented as a polynomial function, such as in Equation (3):

F(x,y)=Qₙxⁿ+Qₙ₋₁xⁿ⁻¹+ . . . +Q₁x¹+Q₀. (3)

where Qₙ through Q₀ are the coefficients of the correction function whose determination is described below. A different set of these Q coefficients is determined for each row of the array. The letter “n” represents the order of the polynomial.

In Equation (3), Q coefficients, Qₙ through Q₀, are determined using polynomial functions. The following polynomials of order m approximate coefficients Qₙ through Q₀:

Qₙ=P_{(n,m)}y^{m}+P_{(n,m-1)}y^{m-1}+ . . . +P_{(n,1)}y¹+P_{(n,0)} (4)

Qₙ₋₁=P_{(n-1,m)}y^{m}+P_{(n-1,m-1)}y^{m-1}+ . . . +P_{(n-1,1)}y¹+P_{(n-1,0}) (5)

. . .

Q₁=P_{(1,m)}y^{m}+P_{(1,m-1)}y^{m-1}+ . . . +P_{(1,1)}y¹+P_{(1,0)} (6)

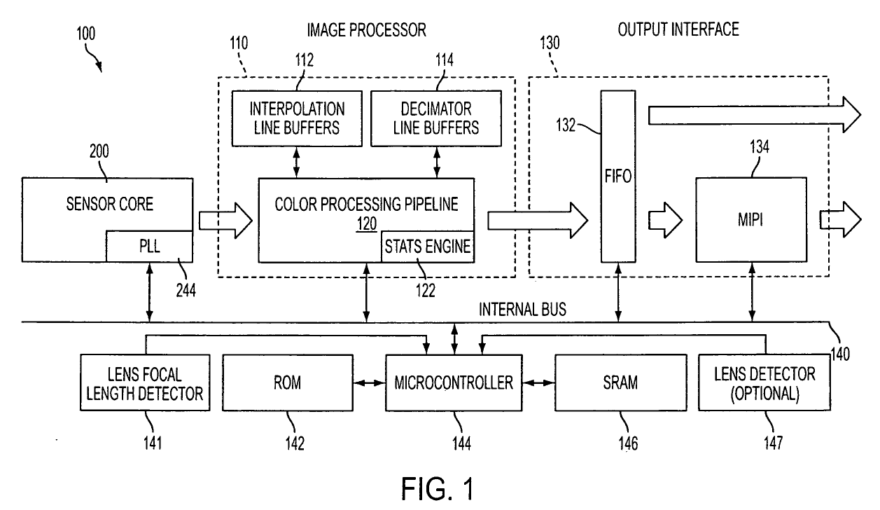

Q₀=P_{(0,m)}y^{m}+P_{(0,m-1)}y^{m-1}+ . . . +P_{(0,1)}y¹+P_{(0,0)} (7)

where P_{(n,m)} through P_{(0,0)} are coefficients determined and stored during imager calibration. The letter “m” represents the order of the polynomial. A more complete explanation of the F(x, y) in Equation (3) may be found in the '303 application. Additionally, as previously noted, the stored positional gain adjustment surface may be represented in storage as a set of parameters used in real time processing to generate the function and calculate a pixel value gain adjustment for each pixel as it is adjusted in a color processing pipeline 120 (FIG. 1, described below).

The parameters or coefficients defining the F(x, y) function provide for the generation of the pixel correction values for a stored positional gain adjustment surface. These “representative parameters” or coefficients are stored, retrieved, and used to generate or evaluate the function F(x, y) for use during positional gain adjustment. Once a pixel correction value is thus generated/determined, it is applied to a pixel value P_{IN}(X, y) from the pixel array (Equation (1)). The (x, y) position of the pixel corresponding to the pixel value (P_{IN}(X, y)) which is to be adjusted may be input into a means for computing the correction function F(x, y) to determine the positional gain adjustment pixel correction value for that pixel, as in the '303 application, or successive pixel correction values may be generated, corresponding to the scan of pixel values from the pixel array, as the scan proceeds, as in the '454 application and the '307 application.

It should be noted that there is one F(x, y) function comprising a positional gain adjustment surface for each color channel. Accordingly, if four color channels are being adjusted by positional gain adjustment (green1, green2, blue, red), there are four F(x, y) functions, respectively, with each color channel corrected in accordance with its own stored positional gain adjustment surface. Alternatively, only three channels (green, blue, red) may have a stored positional gain adjustment surface each with one surface being used for both green1 and green2 channels. As an alternative, there may be only one channel with a stored positional gain adjustment surface, for example, for a monochromatic camera, if only luminance is being corrected by positional gain adjustment. Other color arrays, e.g., with red, green, blue and indigo channels, and associated color channel processing may also be employed.

Prior to camera use, positional gain adjustment surfaces for each color channel respectively corresponding to a plurality of focal lengths of a lens are first determined and these are stored in memory associated with an image processor circuit. The number of stored positional gain adjustment surfaces for each color channel is less than the number of possible focal lengths of the lens. Each stored positional gain adjustment surface is stored either as the pixel correction values that make up the surface or as a set of parameters representing the positional gain adjustment surface and which can be used to generate the surface. The stored positional gain adjustment surfaces corresponding to a particular focal length comprise a set of positional gain adjustment surfaces, one for each color channel.

Before correction begins on a given image, the focal length used during image capture is determined. This may be done by automatic detection or by storage and calculation, etc. If a stored positional gain adjustment surface set corresponding to the determined focal length exists, then that positional gain adjustment surface set is used for positional gain adjustment. If the acquired focal length does not have an associated stored positional gain adjustment surface set, a plurality of stored positional gain adjustment surface sets associated with focal lengths closest to the acquired focal length are used in an interpolation or extrapolation process to create an interpolated or extrapolated set of positional gain adjustment surfaces, one each for the color channels. The gain adjustment value for each pixel is determined by interpolating or extrapolating the pixel correction value generated from the stored positional gain adjustment surfaces for the color channel of that pixel, according to the relative focal lengths of the stored positional gain adjustment surfaces and the desired positional gain adjustment surfaces. The pixel correction value for each pixel is then applied to the corresponding pixel value of the captured image to correct the pixel value corresponding to the pixel.

Interpolated pixel correction values may be calculated from stored positional gain adjustment surfaces corresponding to focal lengths on either side of an acquired focal length. Disclosed embodiments may also calculate extrapolated pixel correction values based on two stored positional gain adjustment surfaces corresponding to focal lengths on one side of the focal length used for image capture. With this capability, surfaces need not be stored for one or more of the extreme minimum and maximum focal lengths.

Additionally, instead of interpolating or extrapolating the pixel correction values for each pixel to obtain the interpolated or extrapolated pixel correction values for each pixel, disclosed embodiments may interpolate or extrapolate the sets of parameters representing the stored positional gain adjustment surfaces to obtain an interpolated or extrapolated set of representative parameters. This interpolated or extrapolated set of parameters may then be used to generate the function representing an interpolated or extrapolated positional gain adjustment surface and the pixel correction values for each pixel may thus be determined, or the set may be used to evaluate the function it represents at any desired pixel, directly and independently.

Turning to FIG. 1, one embodiment is now described in greater detail. FIG. 1 illustrates a block diagram of a system-on-a-chip (SOC) imager 100 which may use any type of imager array technology, e.g., CCD, CMOS, etc.

The imager 100 comprises a sensor core 200 that communicates with an image processor circuit 110 connected to an output interface 130. A phase-locked loop (PLL) 244 is used as a clock for the sensor core 200. The image processor circuit 110, which is responsible for image and color processing, includes interpolation line buffers 112, decimator line buffers 114, and a color processing pipeline 120. The color processing pipeline 120 includes, among other things, a statistics engine 122. One of the functions of the color processing pipeline 120 is the performance of positional gain adjustments in accordance with disclosed embodiments. Image processor circuit 110 may also be implemented as a digital hardware circuit, e.g., an ASIC, a digital signal processor (DSP) or may even be implemented on a stand-alone host computer.

The output interface 130 includes an output first-in-first-out (FIFO) parallel buffer 132 and a serial Mobile Industry Processing Interface (MIPI) output 134, particularly where the imager 100 is used in a camera in a mobile telephone environment. The user can select either a serial output or a parallel output by setting registers in a configuration register within the imager 100 chip. An internal bus 140 connects read only memory (ROM) 142, a microcontroller 144, and a static random access memory (SRAM) 146 to the sensor core 200, image processor circuit 110, and output interface 130. The read only memory (ROM) 142 may serve as a storage location for one or more stored pixel adjustment surfaces. Optional lens focal length detector 141 and lens detector 147 may detect the focal length and the lens used, respectively.

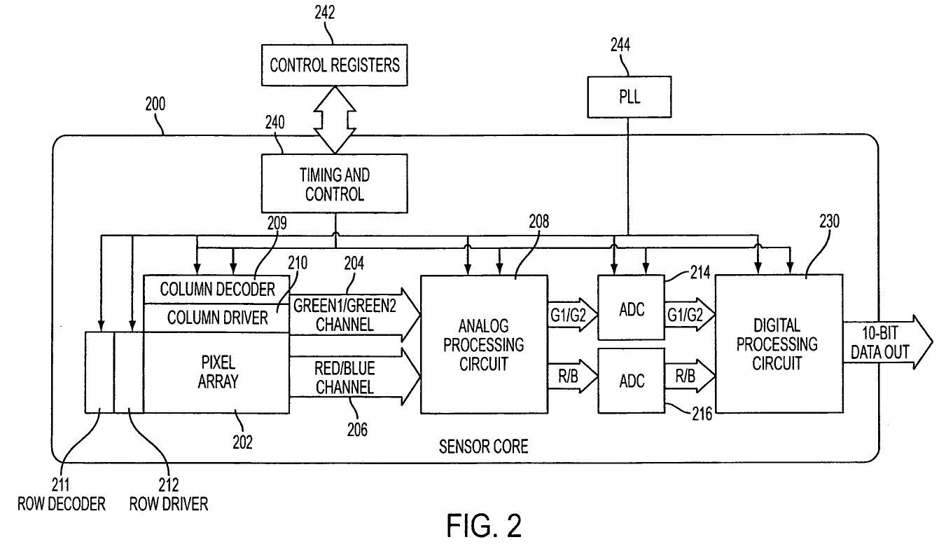

FIG. 2 illustrates a sensor core 200 that may be used in the imager 100 (FIG. 1). The sensor core 200 includes, in one embodiment, a pixel array 202. Pixel array 202 is connected to analog processing circuit 208 by a green1/green2 channel 204 which outputs pixel values corresponding to two green channels of the pixel array 202, and through a red/blue channel 206 which contains pixel values corresponding to the red and blue channels of the pixel array 202.

Although only two channels 204, 206 are illustrated, there are effectively 2 green channels and/or more than the three standard RGB channels. The green1 (i.e., Gr) and green2 (i.e., Gb) signals are read out at different times (using channel 204) and the red and blue signals are read out at different times (using channel 206). The analog processing circuit 208 outputs processed green1/green2 signals G1/G2 to a first analog-to-digital converter (ADC) 214 and processed red/blue signals R/B to a second analog-to-digital converter 216. The outputs of the two analog-to-digital converters 214, 216 are sent to a digital processing circuit 230. It should be noted that the sensor core 200 represents an architecture of a CMOS sensor core; however, disclosed embodiments can be used with any type of solid-state sensor core, including CCD and others.

Connected to, or as part of, the pixel array 202 are row and column decoders 211, 209 and row and column driver circuitry 212, 210 that are controlled by a timing and control circuit 240 to capture images using the pixel array 202. The timing and control circuit 240 uses control registers 242 to determine how the pixel array 202 and other components are controlled. As set forth above, the PLL 244 serves as a clock for the components in the sensor core 200.

The pixel array 202 comprises a plurality of pixels arranged in a predetermined number of columns and rows. For a CMOS imager, the pixels of each row in the pixel array 202 are all turned on at the same time by a row select line and the pixels of each column within the row are selectively output onto column output lines by a column select line. A plurality of row and column lines are provided for the entire pixel array 202. The row lines are selectively activated by row driver circuitry 212 in response to row decoder 211 and column select lines are selectively activated by a column driver 210 in response to column decoder 209. Thus, a row and column address is provided for each pixel. The timing and control circuit 240 controls the row and column decoders 211, 209 for selecting the appropriate row and column lines for pixel readout, and the row and column driver circuitry 212, 210, which apply driving voltage to the drive transistors of the selected row and column lines.

Each column contains sampling capacitors and switches in the analog processing circuit 208 that read a pixel reset signal Vrst and a pixel image signal Vsig for selected pixels. Because the sensor core 200 uses a green1/green2 channel 204 and a separate red/blue channel 206, analog processing circuit 208 will have the capacity to store Vrst and Vsig signals for green1/green2 and red/blue pixel values. A differential signal (Vrst−Vsig) is produced by differential amplifiers contained in the analog processing circuit 208. This differential signal (Vrst−Vsig) is produced for each pixel value. Thus, the signals G1/G2 and R/B are differential signals representing respective pixel values that are digitized by a respective analog-to-digital converter 214, 216. The analog-to-digital converters 214, 216 supply the digitized G1/G2 and R/B pixel values to the digital processing circuit 230 which forms the digital image output (for example, a 10 bit digital output). The output is sent to the image processor circuit 110 (FIG. 1) for further processing. The image processor circuit 110 will, among other things, perform a positional gain adjustment on the digital pixel values of the captured image. Although the invention is described using a CMOS array and associated readout circuitry, disclosed embodiments may be used with any type of pixel array, e.g., CCD with associated readout circuitry, or may be implemented on pixel values of an image not associated with a pixel array.

The color processing pipeline 120 of the image processor circuit 110 performs a number of operations on the pixel values received thereat, one of which is positional gain adjustment. In accordance with disclosed embodiments, the positional gain adjustment is performed using one or more stored positional gain adjustment surfaces available in, for example, ROM 142 or other forms of storage (e.g., registers). The stored positional gain adjustment surfaces for a given channel correspond one each to a pre-defined set of focal lengths of a variable focal length lens e.g., a zoom lens.

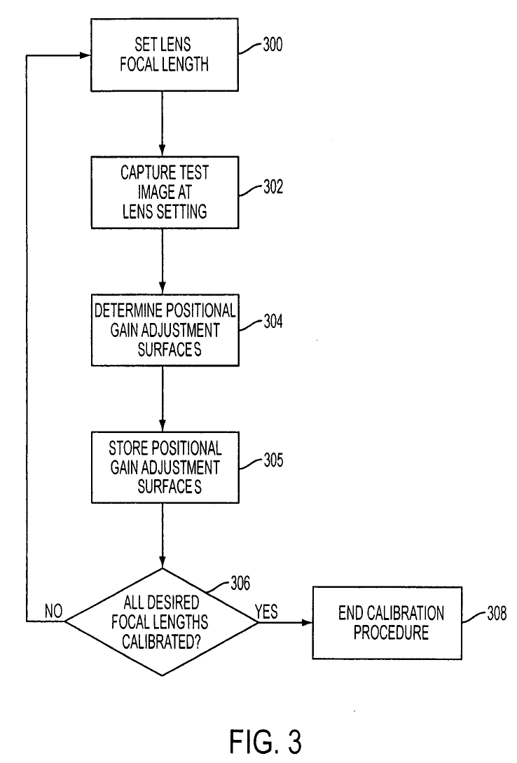

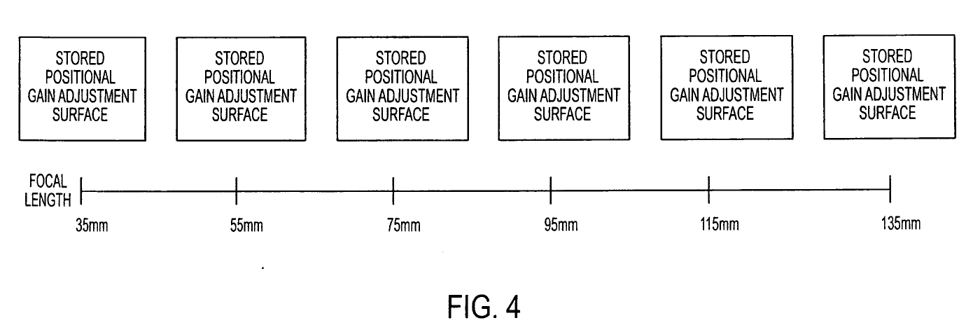

FIG. 3 illustrates how positional gain adjustment surfaces are determined during a calibration procedure. FIG. 4 illustrates representative focal lengths of a zoom lens which may correspond to stored positional gain adjustment surfaces.

Referring to FIG. 3, during a calibration process for imager 100, a variable focal length lens is mounted on a camera containing imager 100. At step 300 of the calibration process, the variable focal length lens is set at one starting focal position. At step 302, a test image is captured while the imager 100 is trained upon a scene of uniform irradiance such as, for example, a uniformly-illuminated grey card. At step 304, the variations in pixel responsiveness across the pixel array 202 are determined for each color channel and a corresponding set of positional gain adjustment surfaces for the color channels representing pixel correction values for each pixel in the pixel array is determined. The set of positional gain adjustment surfaces, including one positional gain adjustment surface for each color channel associated with the pixel array, are stored.

This set of positional gain adjustment surfaces represents a positional gain adjustment value for each pixel of the pixel array which, when for example, multiplied by the associated pixel value, will cause all same channel pixels to have substantially the same values. The set of positional gain adjustment surfaces may be stored, at step 305, either as the actual pixel correction values for the positional gain adjustment surfaces or as sets of parameters representing each function F(x, y) defining each color channel's positional gain adjustment surface. These parameters can be used to generate the value of the positional gain adjustment surface for each pixel as defined by the correction function F(x, y). The set of stored positional gain adjustment surfaces is associated with a stored focal length of the lens used to capture a test image.

After this first positional gain adjustment surface is stored in step 305, the calibration process proceeds to step 306. In step 306, a determination is made as to whether sufficient positional gain adjustment surfaces have been stored to permit embodiments to approximate surfaces for all focal length positions of the lens for which positional gain adjustment is desired. The focal lengths for which positional gain adjustment surfaces are stored include only a subset of all possible focal lengths of the lens. However, the calibration must provide stored positional gain adjustment surfaces for enough focal lengths to enable disclosed embodiments to determine a reasonably close approximation of a set of positional gain adjustment surfaces for focal lengths for which a set of positional gain adjustment surfaces is not stored. Typically, a set of positional gain adjustment surfaces is first determined and stored for an extreme focal length. The lens is moved to a second position and another set of positional gain adjustment surfaces is determined and stored. The first and second positions are as far apart as possible while still allowing a sufficiently accurate approximation, using disclosed embodiments, of positional gain adjustment surfaces corresponding to focal lengths between the first and second positions. Then, the lens is moved to a third position, which again, is as far from the second position as possible while still allowing a sufficiently accurate approximation of positional gain adjustment surfaces corresponding to focal lengths between the second and third positions.

If test images have not been acquired for sufficient focal length positions, the process returns to step 300 where the next focal length position is set. The process repeats steps 300, 302, 304, 305 and 306 until it is determined that each of these focal length positions has a corresponding stored positional gain adjustment surface. The calibration procedure then ends at step 308. It should be recognized that any known imager calibration method may be utilized to determine positional gain adjustment surfaces for storage.

Following the calibration procedure depicted in FIG. 3, imager 100 has a stored set of positional gain adjustment surfaces corresponding to the color channels for each of the calibrated focal lengths, with the number of calibrated focal lengths being less than all possible focal lengths of the lens. FIG. 4 illustrates the association of stored positional gain adjustment surfaces with specific focal lengths of a 35 mm to 135 mm zoom lens, used as an example. One or more test images would be taken (step 302) and a stored positional gain adjustment surface determined (step 304) and stored (step 305) for each of the six focal length positions. In the example, the minimum (35 mm) and maximum (135 mm) positional gain adjustment surfaces are stored, along with four other surfaces corresponding to intermediate focal lengths of 55 mm, 75 mm, 95 mm, and 115 mm.

Although FIG. 4 illustrates an example zoom lens for which six focal length positions are used in the calibration procedure, a greater or fewer number of focal length positions may be used in disclosed embodiments and the focal lengths may or may not be equally spaced, and are typically not equally spaced. Moreover, disclosed embodiments may also be implemented with only two focal length positions of the zoom lens, such as for example a minimum and maximum focal length positions, or, as another example, two intermediate focal length positions, for which stored positional gain adjustment surfaces are determined during calibration. Further, the available focal lengths for a given lens may vary as well, e.g., a focal length range of roughly 5-10 mm may be utilized in a mobile phone application. Additionally, it should be appreciated that the calibration process described above may or may not need to be performed for each individual imager, but if manufacturing tolerances permit can be performed once for a group of imagers having similar pixel value response characteristics and the results may be stored for each imager of the group. It should also be appreciated that zoom position may be represented in units other than the focal length and that these associated units may be stored with the relevant correction surfaces and may be interpolated/extrapolated, etc. as well.

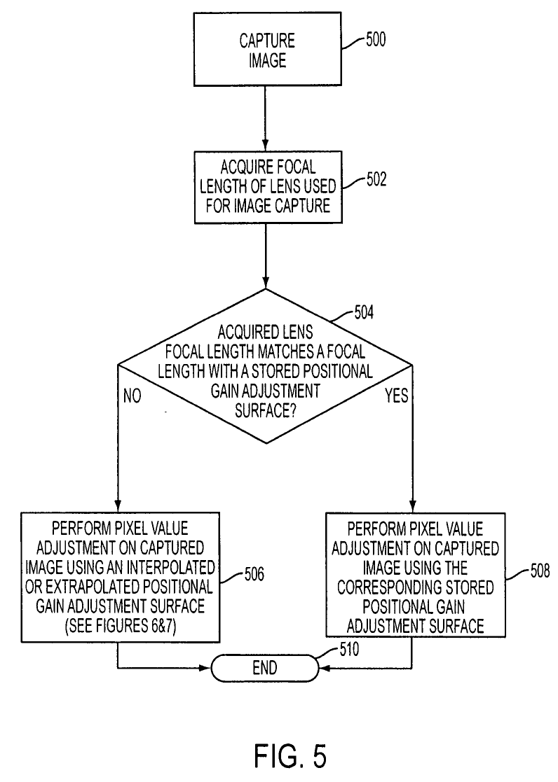

FIG. 5 illustrates in flowchart form a process for performing positional gain adjustment in accordance with disclosed embodiments using the stored positional gain adjustment surfaces. Positional gain adjustment, in accordance with FIG. 5, is performed by image processor circuit 110 of FIG. 1, using one or more stored positional gain adjustment surfaces acquired during the calibration operation (FIG. 4). The image processor circuit 110 has access to the stored positional gain adjustment surfaces in ROM 142 or other memory. The image processor circuit 110 also receives a signal from focal length detector 141, or from a manual input, calculation, etc. representing the current focal length of the variable focal length lens used for image capture. Once the pixel array of pixel values are output by the sensor core 200, the image processor circuit 110 performs positional gain adjustment by adjusting the gain of the pixel values of the captured image. This gain adjustment is implemented using a positional gain adjustment surface corresponding to the determined focal length of the lens.

Referring to FIG. 5, in processing step 500, an image is captured with a lens set to a particular focal length. In step 502, the focal length of the lens used to capture the image is acquired. This can be as an automatic acquisition by detecting the lens focal length using the optional focal length detector 141 as shown in FIG. 1, or it can be a manually entered value, or found in a stored file, etc. In step 504, the image processor circuit 110 determines if the acquired lens focal length matches one of the focal lengths with a corresponding stored positional gain adjustment surfaces.

If in step 504 it is determined that a stored positional gain adjustment surface corresponding to the acquired lens focal length exists, the process proceeds to step 508, where pixel value adjustment is performed on the pixel values of the captured image using the stored positional gain adjustment surface corresponding to the acquired lens focal length. The pixel values are adjusted, as shown in Equation (1), by multiplying a pixel value from the captured image with the pixel correction value for that pixel. The pixel correction value is determined from the stored positional gain adjustment surface—either by accessing the value directly from the positional gain adjustment surface or by calculating a pixel correction value for that pixel from stored parameters describing a function that represents the positional gain adjustment surface. The method of determination depends on how the stored positional gain adjustment surface is represented in memory. Calculating a pixel correction value for that pixel from stored parameters describing a function that represents the positional gain adjustment surface is also discussed in copending application XX/XXX,XXX entitled METHODS, APPARATUSES AND SYSTEMS FOR PIECEWISE GENERATION OF PIXEL CORRECTION VALUES FOR IMAGE PROCESSING, filed XXX (“the 'XXX application) [Attorney Docket No. M4065.1314] the disclosure of which is incorporated herein by reference in its entirety. Following step 508, when positional gain adjustment has occurred for each pixel value of the captured image, the process flow ends at step 510.

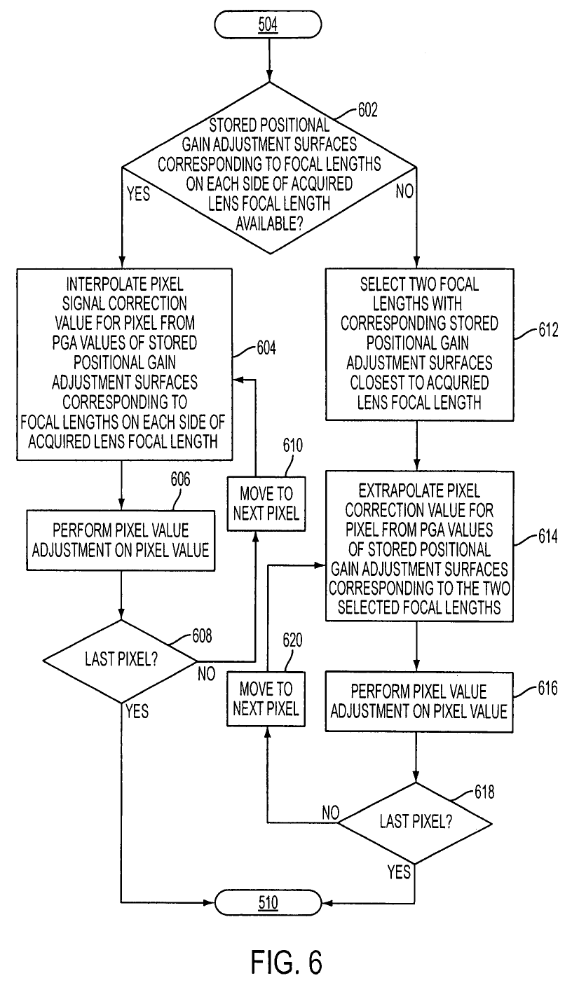

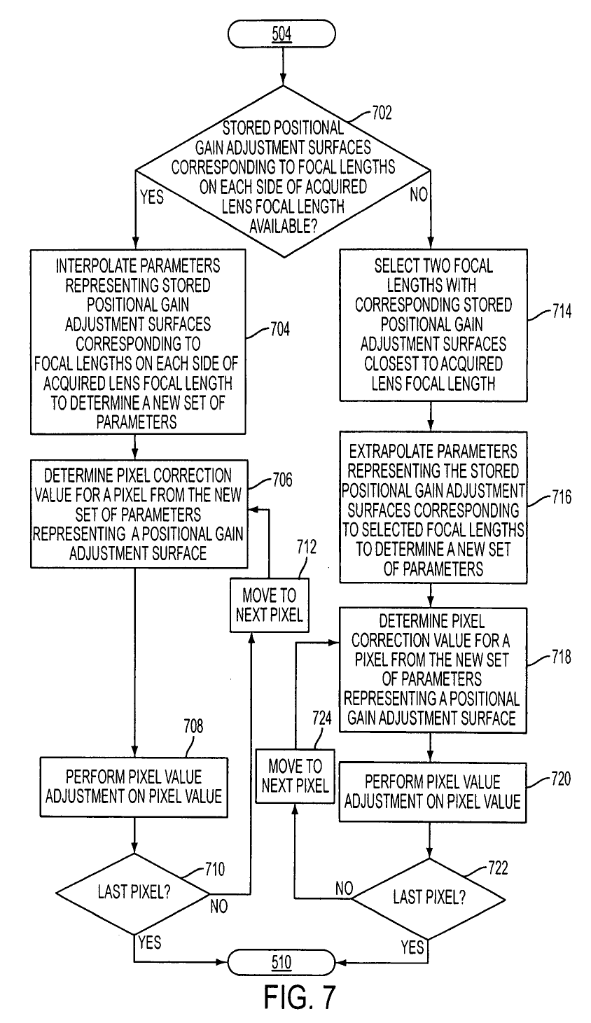

If in step 504, it is determined that there is not a stored positional gain adjustment surface corresponding to the acquired focal length, the process proceeds to step 506, where pixel value adjustment is performed on the pixel values of the captured image using an interpolated or extrapolated positional gain adjustment surface corresponding to the acquired lens focal length. As previously described, the pixel values are adjusted, as shown in Equation (1), by multiplying a pixel value from the captured image with the pixel correction value for that pixel. The pixel correction value is determined based on an interpolation or extrapolation process, described in more detail below with reference to FIGS. 6 and 7. Following step 506, when positional gain adjustment has occurred for each pixel value of the captured image, the process flow ends at step 510.

The pixel value adjustment of step 506 may be implemented by different methods. FIG. 6 illustrates a first method in which the pixel correction value for each pixel is interpolated or extrapolated from the stored positional gain adjustment surfaces. FIG. 7 illustrates a second method in which the parameters representing the stored positional gain adjustment surfaces are interpolated or extrapolated and then the pixel correction value for each pixel is calculated from the parameters representing a new interpolated or extrapolated positional gain adjustment surface. Likewise, an embodiment may include only interpolation and not extrapolation. Including extrapolation may reduce storage requirements, as stored sets of positional gain adjustment surfaces corresponding to fewer focal lengths may be required.

Referring now to FIG. 6, step 506 of FIG. 5 is described in more detail in accordance with a disclosed embodiment. In step 602, a determination is made as to whether there are stored positional gain adjustment surfaces corresponding to focal lengths on each side of the acquired lens focal length available.

If in step 602, it is determined that two adjacent focal lengths are available on either side of the acquired lens focal length, the process proceeds to step 604, wherein a pixel correction value for a first pixel is interpolated from the positional gain adjustment values of the two adjacent stored positional gain adjustment surfaces. For example, using the 35 mm-135 mm zoom lens, discussed above with reference to FIG. 4, if the acquired focal length is 65 mm, the two adjacent positions having associated stored positional gain adjustment surfaces are focal lengths of 55 mm and 75 mm. The interpolated pixel correction values may be calculated for example by a linear weighted mean interpolation or a non-linear interpolation of the positional gain adjustment values of the stored positional gain adjustment surfaces corresponding to 55 mm and 75 mm. In step 606, the interpolated pixel correction value is used to perform pixel value adjustment on the pixel value. Step 608 then determines if the pixel was the last pixel in the image. If not, the process continues at step 610, moving to the next pixel in the image, and then continues to step 604 where an interpolated pixel correction value is determined for this next pixel. Steps 604, 606, 608 and 610 repeat for each pixel in the image. Once pixel value adjustment has occurred for all pixels of the image, the process ends at step 510.

In step 604, if each of the two stored positional gain adjustment surfaces is stored as a plurality of positional gain adjustment values, the two positional gain adjustment values for a pixel may be interpolated to determine the final pixel correction value for the pixel. If each of the two stored positional gain adjustment surfaces is stored as a set of representative parameters, the representative parameters for each of the two stored positional gain adjustment surfaces may be used to determine the actual values of the positional gain adjustment surfaces corresponding to each of the two adjacent focal lengths. The two positional gain adjustment values corresponding to the two positional gain adjustment surfaces for each pixel would then be interpolated in the same manner as if the positional gain adjustment values were stored directly, to determine the appropriate pixel correction values for each of the pixels in the image corresponding to, for example, the 65 mm focal length. The interpolations may be linearly weighted to take into account the differing distances between the acquired lens focal length and each of the focal lengths corresponding to the stored positional gain adjustment values on each side of the acquired focal length. Alternatively, a more accurate interpolation may be provided by a non-linear interpolation such as a polynomial interpolation, possibly requiring fewer stored surfaces.

If in step 602, it is determined that stored surfaces for focal lengths on either side of an acquired focal length are not available, the process proceeds to step 612, wherein two focal lengths with corresponding stored positional gain adjustment surfaces closest to the acquired lens focal length are selected. Then in step 614, a pixel correction value for a first pixel is extrapolated from the positional gain adjustment values of the stored positional gain adjustment surfaces corresponding to the two selected focal lengths selected in step 612. Using the example 35 mm-135 mm zoom lens from FIG. 4, assume there are only stored positional gain adjustment surfaces available for focal length positions of 75 mm, 95 mm, and 105 mm. If the acquired focal length is 65 mm, the two closest focal lengths with corresponding stored positional gain adjustment surfaces are 75 mm and 95 mm, located on the same side of 65 mm. The individual pixel correction values of the stored positional gain adjustment surfaces corresponding to these two focal lengths are used to determine an extrapolated pixel correction value for the first pixel corresponding to the 65 mm focal length, in step 614. The extrapolated pixel correction value may be calculated for example by a linear or non-linear extrapolation of the pixel correction values of the stored positional gain adjustment surfaces corresponding to 75 mm and 95 mm. In step 616, the extrapolated pixel correction value is used to perform pixel value adjustment on the pixel value. Step 618 then determines if the pixel was the last pixel in the image. If not, the process continues at step 620, moving to the next pixel in the image, and then continues to step 614 where an extrapolated pixel correction value is determined for this next pixel. Steps 614, 616, 618 and 620 repeat for each pixel in the image. Once pixel value adjustment has occurred for all pixels of the captured image, the process ends at step 510.

In step 614, if each of the two selected stored positional gain adjustment surfaces is stored as a plurality of positional gain adjustment values, the two positional gain adjustment values for a given pixel may be extrapolated in order to form the final pixel correction value for the pixel. If each stored positional gain adjustment surface is stored as a set of representative parameters, the values of the stored representative parameters may be used to determine the positional gain adjustment surfaces whose values are extrapolated, as just described, to determine the final pixel correction value for each pixel in the image. The extrapolation may be linear or, alternatively, a more accurate extrapolation may be provided by a non-linear extrapolation such as a polynomial extrapolation, possibly permitting the use of fewer stored surfaces.

Referring now to FIG. 7, step 506 of FIG. 5 is described in more detail in accordance with an additional embodiment. In step 702, a determination is made as to whether there are stored positional gain adjustment surfaces corresponding to focal lengths on each side of the acquired lens focal length available.

If in step 702, it is determined that two focal lengths are available on either side of the acquired lens focal length, the process proceeds to step 704, wherein the parameters representing the two stored positional gain adjustment surfaces corresponding to the closest focal length on each side of the acquired lens focal length are interpolated to determine a new set of parameters representing a positional gain adjustment surface corresponding to the acquired lens focal length. The interpolations may be linearly weighted to take into account the differing distances between the acquired lens focal length and each of the focal lengths corresponding to the stored positional gain adjustment values on each side of the acquired focal length. Alternatively, a more accurate interpolation may be provided by a non-linear interpolation such as a polynomial interpolation, possibly requiring fewer stored surfaces.

In step 706, the new set of interpolated parameters is used to determine the pixel correction value for a first pixel. This is done by evaluating the positional gain adjustment surface corresponding to the acquired lens focal length from the new set of interpolated parameters. In step 708, pixel value adjustment is performed on the pixel value using the pixel correction value from step 706. Step 710 then determines if the pixel was the last pixel in the image. If not, the process continues at step 712, moving to the next pixel in the image, and then continues to step 706 where a pixel correction value is determined for this next pixel. Steps 706, 708, 710 and 712 repeat for each pixel in the image. Once pixel value adjustment has occurred for all pixels of the captured image, the process ends at step 510.

If in step 702, it is determined that stored surfaces for focal lengths on either side of an acquired focal length are not available, the process proceeds to step 714, wherein two focal lengths with corresponding stored positional gain adjustment surfaces closest to the acquired lens focal length are selected. In step 716, the parameters representing the stored positional gain adjustment surfaces corresponding to the selected focal lengths are extrapolated to determine a new set of extrapolated parameters representing a positional gain adjustment surface corresponding to the acquired lens focal length. The extrapolation may be linear or, alternatively, a more accurate extrapolation may be provided by a non-linear extrapolation such as a polynomial extrapolation, possibly permitting the use of fewer stored surfaces.

In step 718, the new set of extrapolated parameters is used to determine the pixel correction value for a first pixel. This is done by evaluating the positional gain adjustment surface corresponding to the acquired lens focal length from the new set of extrapolated parameters. In step 720, pixel value adjustment is performed on the pixel value using the pixel correction value from step 718. Step 722 then determines if the pixel was the last pixel in the image. If not, the process continues at step 724, moving to the next pixel in the image, and then continues to step 718 where a pixel correction value is determined for this next pixel. Steps 718, 720, 722 and 724 repeat for each pixel in the image. Once pixel value adjustment has occurred for all pixels of the captured image, the process ends at step 510.

It should be noted with respect to the FIG. 7 embodiment that at a given color pixel, the whole surface for each color channel at a particular focal length need not be generated, as only the surface corresponding to the color of the pixel being captured at a particular time needs to be evaluated. Thus, as different color pixels are evaluated, different surfaces can be evaluated, e.g., the red surfaces need not be evaluated at a blue pixel. Alternatively, the entire surface can be generated and values for pixels at different locations on the surface can be selected and used for corrections.

The method of pixel value adjustment described with reference to FIG. 7 is applicable only when the stored positional gain adjustment surfaces may be interpolated/extrapolated by means of interpolation/extrapolation of their parameters, for example as in Equations (3) through (7) above and cannot be applied when the stored positional gain adjustment surfaces are stored in a piecewise quadratic fashion, as in Equation (2).

As an example to compare the methods of FIG. 6 and FIG. 7, consider a positional gain adjustment algorithm that generates the pixel gain adjustment factor with a polynomial evaluated at each pixel location. For simplicity, the example is a one-dimensional polynomial (whereas positional gain adjustment typically is two-dimensional, as it operates on two-dimensional images). Equations (8) and (9) are functional representations of the two positional gain adjustment surfaces which are being interpolated.

S₁(x)=aₙxⁿ+aₙ₋₁xⁿ⁻¹+ . . . +a₁x+a₀; (8)

S₂(x)=bₙxⁿ+bₙ₋₁xⁿ⁻¹+ . . . +b₁x+b₀, (9)

where S₁(x) and S₂(x) are stored positional gain adjustment surfaces, and aₙ, aₙ₋₁, . . . , a₁ and a₀ and bₙ, . . . , bₙ₋₁, b₁ and b₀ are the parameters which are actually stored to represent the stored positional gain adjustment surfaces. Equation (10) is a representation of an interpolated positional gain adjustment surface based upon a linear interpolation of the adjustment surfaces:

S(x)=k₁S₁(x)+k₂S₂(x), (10)

where S(x) is the interpolated positional gain adjustment surface, k₁ represents the first interpolation coefficient, or the proportion of the distance between the focal lengths corresponding with S₁(x) and S₂(x) that the acquired lens focal length (corresponding to S(x)) is from the focal length corresponding with S₂(x), and k₂ represents the second interpolation coefficient, or the proportion of the distance between the focal lengths corresponding with S₁(x) and S₂(x) that the acquired lens focal length (corresponding to S(x)) is from the focal length corresponding with S₁(x). This corresponds to FIG. 6; each of the S₁(x) and S₂(x) is evaluated then interpolated or extrapolated, as needed.

Instead of generating each of these surfaces and then interpolating the final result, it is possible to interpolate the coefficients of the polynomials to obtain a representation of the positional gain adjustment surface that is desired. Equation (11) is a representation of an interpolated positional gain adjustment surface for a desired focal length based upon a linear interpolation of the parameters representing the positional gain adjustment surfaces for focal lengths on either side:

S_{efficient}(x)=(k₁aₙ+k₂bₙ)xⁿ+(k₁aₙ₋₁+k₂bₙ₋₁)xⁿ⁻¹+ . . . +(k₁a₁+k₂b₁)x+(k₁a₀+k₂b₀), (11)

where S_{efficient}(x) is the interpolated positional gain adjustment surface, aₙ, aₙ₋₁, . . . , a₁ and a₀ and bₙ, bₙ₋₁, . . . , b₁ and b₀ represent the parameters which are stored to represent the stored positional gain adjustment surfaces S₁(x) and S₂(x), k₁ represents the first interpolation coefficient, or the proportion of the distance between the focal lengths corresponding with S₁(x) and S₂(x) that the acquired lens focal length (corresponding to S(x)) is from the focal length corresponding with S₂(x), and k₂ represents the second interpolation coefficient, or the proportion of the distance between the focal lengths corresponding with S₁(x) and S₂(x) that the acquired lens focal length (corresponding to S(x)) is from the focal length corresponding with S₁(x). This corresponds to FIG. 7.

In the above example, S(x) and S_{efficient}(x) are mathematically equivalent, enabling the method of FIG. 7. Although, in the example, the evaluation of the positional gain adjustment surface based on the interpolation of the positional gain adjustment parameters is mathematically equivalent to the corresponding interpolation of the positional gain adjustment output values, this is not required by disclosed embodiments. If at least rough equivalence does not hold, the method of FIG. 6 is used. It should be understood that two positional gain adjustment parameter sets that each correspond to distinct positional gain adjustment output surfaces are used in this generation of another positional gain adjustment surface that is located between the first two positional gain adjustment surfaces. This same procedure of interpolating the parameters instead of the evaluated positional gain adjustment surfaces may also apply to extrapolation, as in step 716 of FIG. 7.

In step 506 of FIG. 5, the required hardware and/or software resources may be reduced, or the calculation done more quickly, if the interpolated/extrapolated positional gain adjustment surface is determined by interpolating/extrapolating the representative parameters and then calculating the desired positional gain adjustment surface from the new set of representative parameters (as described with reference to FIG. 7) rather than if the two positional gain adjustment surfaces are determined from the representative parameters and then the values of these two positional gain adjustment surfaces are interpolated or extrapolated to obtain the desired pixel correction values (as described with reference to FIG. 6). In FIG. 7, interpolation is performed only once per frame, in Step 704. (In FIG. 6, Step 604 is repeated for each pixel, burdening the computation resources.) Interpolated parameters are held and used for evaluating S_{efficient}(x) directly, at each pixel. Since only one surface is evaluated at each pixel, computation is simplified, thereby reducing the hardware or processing time requirements as compared to the implementation of FIG. 6.

Positional gain adjustment need not be applied to the pixel values corresponding to all the pixels of a pixel array. Accordingly, corrections may be performed for only selected pixels in a captured image, as described in the '307 application, previously discussed.

While disclosed embodiments have been described for use in correcting positional gains for a captured image based on a single variable, i.e., lens focal length, disclosed embodiments may also be implemented such that two or more input parameters are used to select the appropriate set of positional gain adjustment surfaces. For example, if the focal length and the color temperature are variables to be taken into account during image processing, then the appropriate set of positional gain adjustment surfaces will be determined from both of these parameters. A set of positional gain adjustment surfaces (one for each color channel) would be stored for each of a plurality of pairs (f, c) of focal length and color temperature. In determining the set of positional gain adjustment surfaces to be used for image correction, the stored surfaces for the four pairs closest to the actual focal length/color temperature combination are interpolated by bi-linear interpolation to form the desired positional gain adjustment surface. This same type of multi-linear interpolation could be implemented in multiple dimensions with the positional gain adjustment surfaces taking into account several varying states of the lens.

While disclosed embodiments have been described for use in correcting positional gains for the pixel values of a captured image, the systems, methods and apparatuses discussed herein may be used for other pixel value corrections, e.g., crosstalk correction, needed when the spatial pattern of correction values is affected by the differing focal lengths of a variable focal length lens. Likewise, spatial variations caused by other factors, instead of or in addition to varying focal lengths, such as changes in iris opening, varying focus positions, or varying light source color temperatures, (e.g., daylight, fluorescent, tungsten, etc.), can also be corrected using the disclosed embodiments. One such use is to correct for crosstalk among adjacent pixels of an array. Crosstalk patterns may change across an array and this variation may depend on the focal length of a lens used to acquire an image. Accordingly, crosstalk correction surfaces may be acquired from test images for a predetermined number of focal lengths of a variable focal length lens and used in the manner described above in the pixel processing pipeline to correct such crosstalk patterns which change based on the focal length of a lens.

When employed in a video camera, pixel value corrections may be employed in real time for each captured frame of the video image.

Disclosed embodiments may be implemented as part of a camera such as e.g., a digital still or video camera, or other image acquisition system, and also may be implemented as a stand-alone or plug-in software component for use in image processing applications. In such applications, the process described in FIG. 5 from steps 502 to 512 can be implemented as computer instruction code contained on a storage medium for use in a computer image processing system, or with image processing hardware, etc.

Disclosed embodiments may also be implemented for digital cameras having interchangeable variable focal length lenses. In such an implementation, for each of a plurality of variable focal length lenses, a plurality of positional gain adjustment surfaces are acquired (FIG. 3) and stored for a plurality of focal length positions. The camera will sense with lens detector 147 (FIG. 1), which interchangeable variable focal length lens is being used with the camera. Alternatively, this information may be manually entered. The camera then uses the lens detection and focal length detection information to compute an appropriate positional gain adjustment surface corresponding to a detected lens and focal length for use in performing the positional gain adjustment.

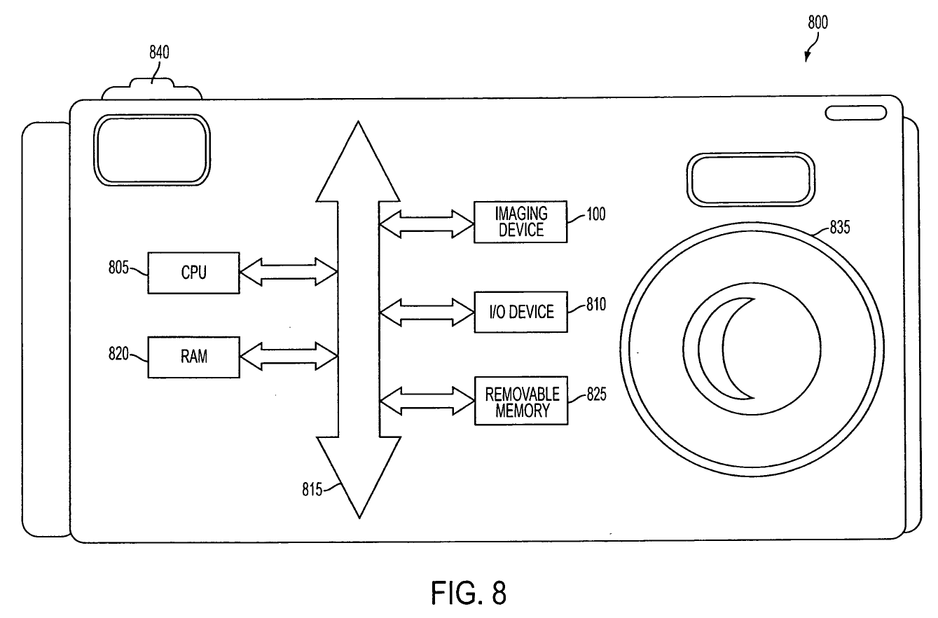

For example, FIG. 8 illustrates a processor system as part of a digital still or video camera system 800 employing a system-on-a-chip imager 100 as illustrated in FIG. 1, which imager 100 provides positional gain adjustment and/or other pixel value corrections as described above. The processing system includes a processor 805 (shown as a CPU) which implements system, e.g. camera 800, functions and also controls image flow and image processing. The processor 805 is coupled with other elements of the system, including random access memory 820, removable memory 825 such as a flash or disc memory, one or more input/output devices 810 for entering data or displaying data and/or images and imager 100 through bus 815 which may be one or more busses or bridges linking the processor system components. A lens 835 allows an image or images of an object being viewed to pass to the pixel array 202 of imager 100 when a “shutter release”/“record” button 840 is depressed.

The camera system 800 is only one example of a processing system having digital circuits that could include image sensor devices. Without being limiting, such a system could also include a computer system, cell phone system, scanner, machine vision system, vehicle navigation system, video phone, surveillance system, auto focus system, star tracker system, motion detection system, image stabilization system, and other image processing systems.

While disclosed embodiments have been described in detail, it should be readily understood that the invention is not limited to the disclosed embodiments. Rather the disclosed embodiments can be modified to incorporate any number of variations, alterations, substitutions or equivalent arrangements not heretofore described.

1. An imaging system comprising:
an input for receiving information on a set focal length of a lens;
an array of pixels for capturing an image, each pixel having at least one photosensor;
a storage circuit for storing a plurality of pixel value adjustment surfaces for at least some pixels of the array, each respectively corresponding to a possible focal length of the lens; and
a processing circuit for gain adjustment processing of pixel output signals produced by the array of pixels and corresponding to a captured image, the gain adjustment processing being performed in accordance with received information on the set focal length of the lens and a pixel value adjustment surface corresponding to the set focal length which is determined from one or more of the stored pixel value adjustment surfaces.

2. An imaging system as in claim 1, wherein the plurality of stored pixel value adjustment surfaces are stored as respective sets of parameters representing the stored pixel value adjustment surfaces.

3. An imaging system as in claim 1, wherein each of the plurality of pixel value adjustment surfaces is stored as a set of pixel gain adjustment values.

4. An imaging system as in claim 1, wherein the processing circuit is configured to interpolate a pixel value adjustment surface corresponding to the set focal length from at least two adjacent stored pixel value adjustment surfaces and to use the interpolated pixel value adjustment surface in performing the gain adjustment processing.

5. An imaging system as in claim 2, wherein the processing circuit is configured to determine at least two pixel value adjustment surfaces from the sets of parameters representing the at least two stored pixel value adjustment surfaces, to interpolate from the at least two pixel value adjustment surfaces an interpolated pixel value adjustment surface corresponding to the set focal length, and to use the interpolated pixel value adjustment surface in performing the gain adjustment processing.

6. (canceled)

7. An imaging system as in claim 2, wherein the processing circuit is configured to interpolate a set of interpolated parameters from at least two sets of parameters representing at least two stored pixel value adjustment surfaces, the set of interpolated parameters representing an interpolated pixel value adjustment surface corresponding to the set focal length, to determine the interpolated pixel value adjustment surface from the interpolated set of parameters, and to use the interpolated pixel value adjustment surface in performing the gain adjustment processing.

8. An imaging system as in claim 1, wherein the processing circuit is configured to extrapolate a pixel value adjustment surface corresponding to the set focal length from at least two stored pixel value adjustment surfaces and to use the extrapolated pixel value adjustment surface in performing the gain adjustment processing.

9. An imaging system as in claim 2, wherein the processing circuit is configured to determine at least two pixel value adjustment surfaces from the sets of parameters representing the at least two stored pixel value adjustment surfaces, to extrapolate from the at least two pixel value adjustment surfaces an extrapolated pixel value adjustment surface corresponding to the set focal length, and to use the extrapolated pixel value adjustment surface in performing the gain adjustment processing.

10. (canceled)

11. An imaging system as in claim 2, wherein the processing circuit is configured to extrapolate a set of extrapolated parameters from at least two sets of parameters representing at least two stored pixel value adjustment surfaces, the set of extrapolated parameters representing an extrapolated pixel value adjustment surface corresponding to the set focal length, to determine the extrapolated pixel value adjustment surface from the extrapolated set of parameters, and to use the extrapolated pixel value adjustment surface in performing the gain adjustment processing.

12-19. (canceled)

20. An imaging system as in claim 1 further comprising a lens focal length detector for producing the information on the set focal length of the lens.

21. An imaging system as in claim 20, wherein the lens focal length detector is configured to automatically produce the information on the set focal length of the lens.

22-28. (canceled)

29. A digital camera comprising:
a lens;
a pixel array for capturing an image received through the lens;
a storage area for storing a plurality of pixel value adjustment surfaces for at least some pixels of the array in respective correspondence to a plurality of different possible focal lengths of the lens; and
a processing circuit for correcting pixel values of at least some pixels of the pixel array using a pixel adjustment surface corresponding to a detected optical state of the lens, wherein the processing circuit is configured to determine if the pixel value adjustment surface corresponding to the detected optical state is a stored pixel value adjustment surface, and if not, to determine an interpolated pixel value adjustment surface by one of interpolation or extrapolation from at least two stored pixel value adjustment surfaces.

30-53. (canceled)

54. An imaging system comprising:
a storage circuit for storing a plurality of pixel value adjustment surfaces corresponding to respective focal lengths of a variable focal length lens to be used with the imaging system;
a pixel array for capturing an image; and
a pixel value processing circuit for processing pixel values of an image captured by the pixel array, the processing circuit being configured to use at least two of the stored pixel value adjustment surfaces to form a pixel value adjustment surface corresponding to a detected focal length of the lens for application to pixel values of a captured image.

55. An imaging system as in claim 54, wherein the processing circuit is configured to interpolate or extrapolate pixel value adjustment surfaces for application to pixel values of the captured image from at least two stored pixel value adjustment surfaces.

56. An imaging system as in claim 54, wherein the at least two stored pixel value adjustment surfaces are stored as sets of parameters representing the at least two stored pixel value adjustment surfaces and these sets of parameters are interpolated or extrapolated to obtain a set of interpolated or extrapolated parameters, respectively, which are used to determine the pixel value adjustment surfaces for application to pixel values of the captured image.

57-82. (canceled)

83. A circuit configured to perform the acts of:
receiving information on a focal length of a lens used to capture an image;
receiving an image captured by the lens at the focal length;
processing the image by interpolating or extrapolating a pixel value adjustment surface corresponding to the received focal length from at least two stored pixel value adjustment surfaces corresponding to different focal lengths of the lens, and using the interpolated or extrapolated pixel value adjustment surface to correct pixel values corresponding to pixels of the captured image.

84-85. (canceled)

86. A circuit as in claim 83, wherein the act of interpolation is performed using two stored pixel value adjustment surfaces corresponding to focal lengths on either side of the received focal length.

87. A circuit as in claim 83, wherein the act of extrapolation is performed using two stored pixel value adjustment surfaces corresponding to focal lengths on one side of the received focal length.

88-112. (canceled)

113. A method of processing an image, the method comprising:
acquiring information on a focal length of a lens used to capture an image; and
processing an image captured by the lens at the focal length by determining a set of pixel correction values for the focal length from at least two stored sets of pixel correction values corresponding to different focal lengths of the lens, and using the determined set of pixel correction values to correct pixel values of the image.

114-115. (canceled)

116. A method as in claim 113, wherein the act of determining a set of pixel correction values comprises an interpolation performed using two stored sets of pixel correction values corresponding to focal lengths on either side of the focal length used to capture the image.

117. (canceled)

118. A method as in claim 113, wherein the act of determining a set of pixel correction values comprises an extrapolation performed using two stored sets of pixel correction values corresponding to focal lengths closest to and on the same side of the focal length used to capture the image.

119-121. (canceled)

122. A method as in claim 113, wherein each set of pixel correction values is stored as a set of parameters representing the set of pixel correction values and determining the determined set of pixel correction values comprises:
determining at least two sets of pixel correction values from the sets of parameters representing the at least two stored sets of pixel correction values; and
interpolating from the at least two sets of pixel correction values an interpolated set of pixel correction values corresponding to the, input focal length, wherein the interpolated set of pixel correction values is the determined set of pixel correction values.

123. A method as in claim 113, wherein each set of pixel correction values is stored as a set of parameters representing the set of pixel correction values and determining the determined set of pixel correction values comprises:
interpolating from the sets of parameters representing the at least two sets of pixel correction values an interpolated set of parameters representing an interpolated set of pixel correction values which corresponds to the acquired focal length; and
determining the interpolated set of pixel correction values from the interpolated set of parameters representing the interpolated set of pixel correction values, wherein the interpolated set of pixel correction values is the determined set of pixel correction values.

124. A method as in claim 113, wherein each set of pixel correction values is stored as a set of parameters representing the set of pixel correction values and determining the determined set of pixel correction values comprises:
determining at least two sets of pixel correction values from the sets of parameters representing the at least two stored sets of pixel correction values; and
extrapolating from the at least two sets of pixel correction values an extrapolated set of pixel correction values corresponding to the input focal length, wherein the extrapolated set of pixel correction values is the determined set of pixel correction values.

125. A method as in claim 113, wherein each set of pixel correction values is stored as a set of parameters representing the set of pixel correction values and determining the determined set of pixel correction values comprises:
extrapolating from the sets of parameters representing the at least two sets of pixel correction values an extrapolated set of parameters representing an extrapolated set of pixel correction values which corresponds to the acquired focal length; and
determining the extrapolated set of pixel correction values from the extrapolated set of parameters representing the extrapolated set of pixel correction values, wherein the extrapolated set of pixel correction values is the determined set of pixel correction values.
